(19) United States
(12) Patent Application Publication
(10) Pub. No.: US 2010/0061474 A1
(43) Pub. Date: Mar. 11, 2010

(54) FFT SPREADING AMONG SELECTED OFDM SUB-CARRIERS

(75) Inventor: Charles Razzell, Pleasanton, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/597,469

(22) PCT Filed: May 3, 2008
(86) PCT No.: PCT/IB08/51716

§ 371 Date: Oct. 23, 2009

Related U.S. Application Data
(60) Provisional application No. 60/916,183, filed on May 4, 2007.

(51) Int. Cl. H04L 27/28

(52) U.S. Cl. 375/260

(57) ABSTRACT

An improved communications system for frequency-selective fading channels spreads the data-bearing modulation symbols across many OFDM sub-carriers using a discrete Fourier transform (FFT) at the transmitter, and despreads them using an inverse discrete Fourier transform (IFFT) at the receiver. An IFFT is included at the transmitter to form the OFDM symbols in the usual way, and a corresponding FFT is used at the receiver for the frequency-domain processing of the received signal. The difference is, the size of the FFT used for spreading at the transmitter is smaller than that of an IFFT used just after the FFT to create the OFDM symbols for transmission. This results in improved bit-error-rate, similar to single carrier block transmission (SCBT), while retaining the frequency domain benefits of conventional OFDM, e.g., low out of band emissions and the ability to control the power spectral density using active interference cancellation and other frequency-domain techniques. The improved frequency diversity is especially useful in the higher data rate modes of WLAN or WiMedia Physical Layer Standards, and in other cases where low redundancy forward error correction is employed.

This invention relates to communications systems, and more particularly to orthogonal frequency division multiplexing equipment and methods.

There are three different variations of wireless local area networks (WLAN) defined by IEEE standards, e.g., (1) 802.11a, (2) 802.11b, and 802.11g. The IEEE-802.11a operates in the 5-GHz ISM band, while 802.11b and 802.11g operate in the 2.4-GHz ISM band. A variety of data rates and modulation techniques are used to encode data rates varying from 1 Mb/s to 54 Mb/s. All of these systems use time division duplexing, and the data is transmitted in variable-length frames. Each IEEE standard also specifies several test modes with fixed times and duty cycle rates.

A 802.11b WLAN transmitter can use either binary phase shift keying (BPSK) or quadrature phase shift keying (QPSK). The modulation in the power envelope has an effect on the peak to average power ratio. Both 802.11a and 802.11g WLAN transmitters can use orthogonal frequency division multiplexing (OFDM) that uses forty-eight separate data sub-carriers, and four pilot carriers. A correspondingly lower data rate is used on each carrier. The advantage of this system is that it can reduce errors introduced by multi-path propagation at high data rates. Systems based on OFDM have higher data rates and longer range compared with conventional single carrier systems. A variety of modulation schemes are used to convey the data, e.g., ranging from the lowest data rate with BPSK to 54 Mb/s with 64-state quadrature amplitude modulation (64QAM).

Single carrier transmission systems require pulse shaping filters to reduce the out-of-band spectrum that would otherwise result from direct use of a typical QAM modulation scheme. Such filters are typically implemented in the time-domain using an approximation to the Root Raised Cosine pulse shape, which has an excess bandwidth α, compared to the modulation Baud rate, so that the total occupied bandwidth at the 3 dB points is B(1+α). Tight control of the excess bandwidth requires longer pulse shaping filters for adequate representation of the impulse response, and can be computationally prohibitive when implemented as digital FIR filters. Alternatively, analogue pulse shaping may be used which suffers from variability with component tolerances and may be a poor approximation to the ideal Root Raised-Cosine response.

Walsh-Hadamard spreading of OFDM has also been studied. The difficulty is Walsh-Hadamard transforms are only defined for blocks with a length given by a power of two. So, where pilot symbols are to be preserved in place, only very small Walsh-Hadamard spreading block lengths can be used, and that limits the frequency diversity that can be attained.

OFDM makes efficient use of bandwidth, and has no excess bandwidth requirement. What is needed is a transmission scheme that is economical to implement and has the frequency domain advantages of OFDM. It should obtain the best possible frequency diversity over frequency-selective fading channels. Such fading is very typical for indoor WLAN and UWB. And in particular what is needed is the ability to use high rate forward error correction to maximize the data rates possible in the communications channel.

In an example embodiment, an improved communications system for frequency-selective fading channels spreads the data-bearing modulation symbols across many OFDM sub-carriers using a discrete Fourier transform (FFT) at the transmitter, and despreads them back using an inverse discrete Fourier transform (IFFT) at the receiver. An IFFT is included at the transmitter to form the OFDM symbols in the usual way, and a corresponding FFT is used at the receiver for the frequency-domain processing of the received signal. The essential improvement is the size of the FFT used for spreading at the transmitter is smaller than that of an IFFT used just after the FFT to create the OFDM symbols for transmission.

The above summary of the present invention is not intended to represent each disclosed embodiment, or every aspect, of the present invention. Other aspects and example embodiments are provided in the figures and the detailed description that follows.

The invention may be more completely understood in consideration of the following detailed description of various embodiments of the invention in connection with the accompanying drawings, in which:

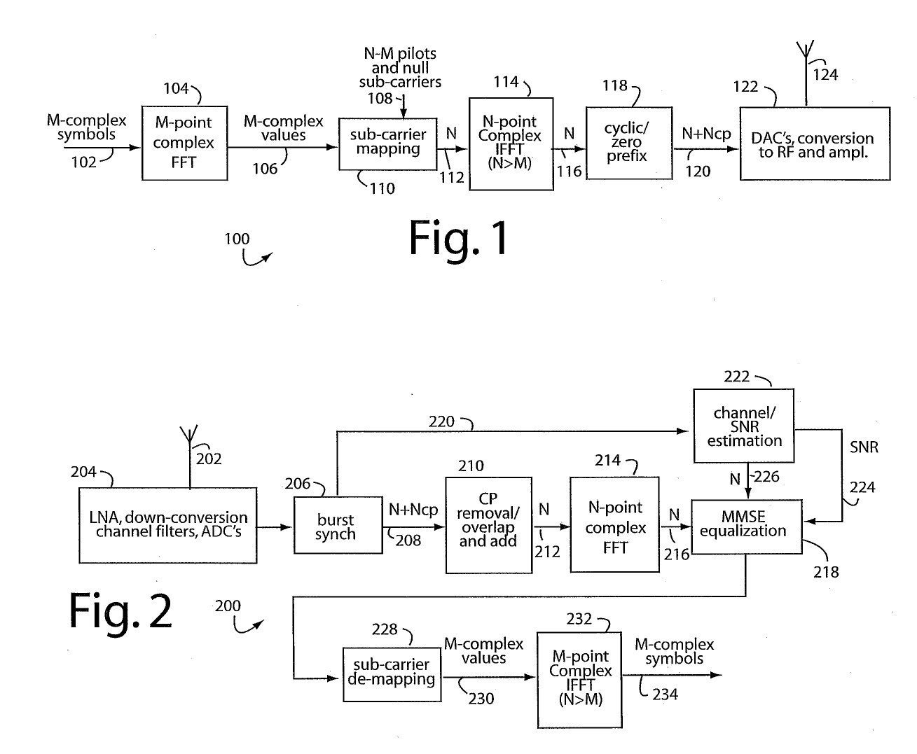

FIG. 1 is a functional block diagram of an OFDM wireless transmitter embodiment of the present invention and includes an M-point complex FFT of smaller size than the N-point complex IFFT that follows thereafter;

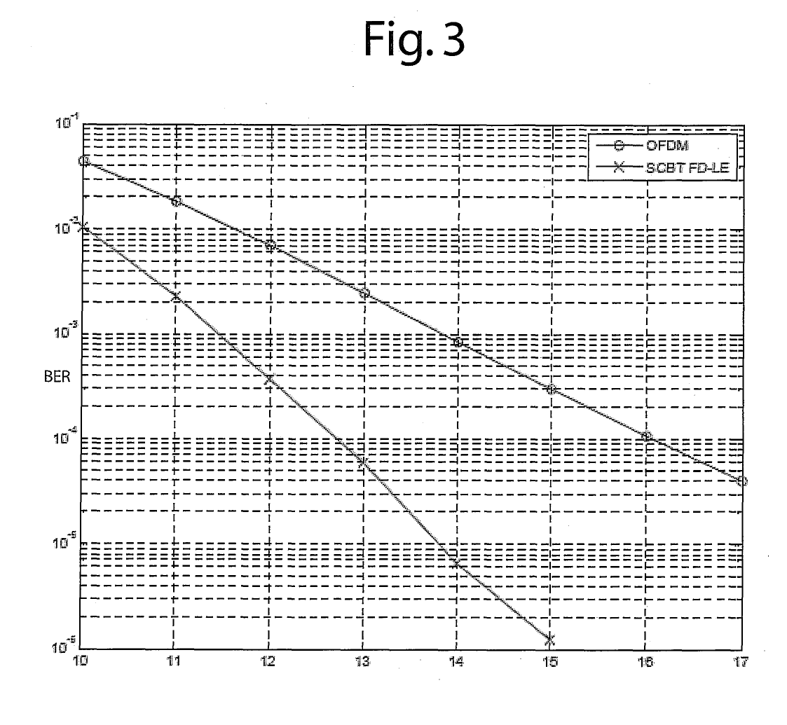

FIG. 2 is a functional block diagram of an OFDM wireless receiver embodiment of the present invention and includes an N-point complex FFT of larger size than the M-point complex IFFT that follows thereafter;

FIG. 3 is a graph representing the improved bit-error-rate (BER) performance obtained by the FFT spreading of symbols as in the transmitter and receiver combination in FIGS. 1 and 2;

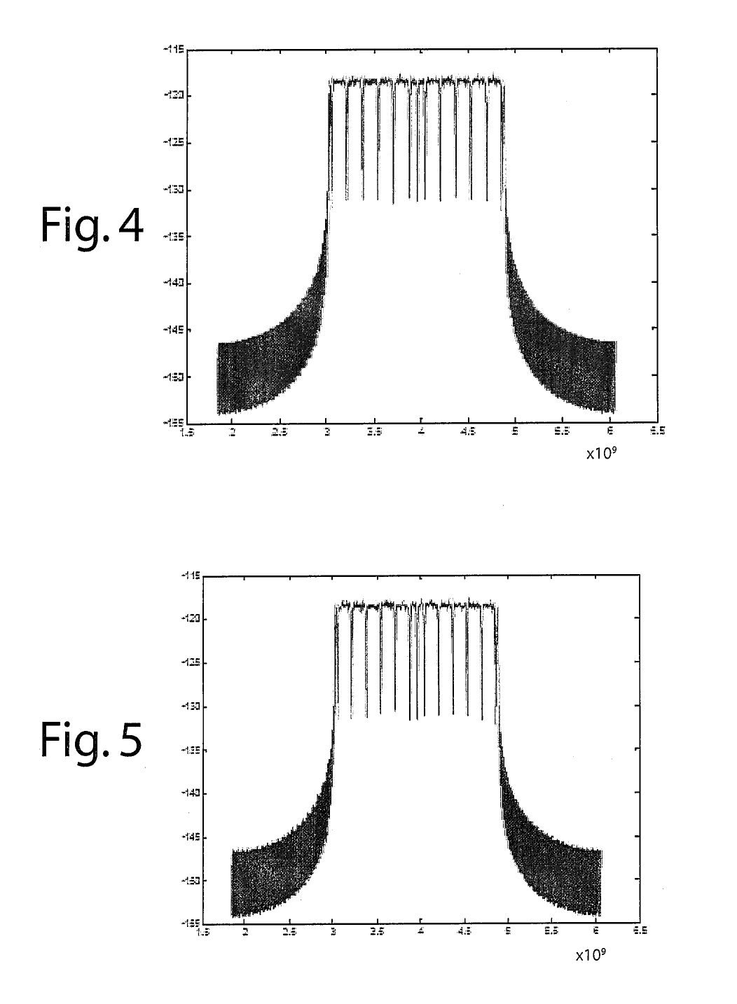

FIG. 4 shows the power spectral density of conventional OFDM pilot sub-carriers removed; and

FIG. 5 represents the power spectral density of embodiments of the present invention with pilot sub-carriers removed.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

OFDM is a multi-carrier modulation technique that effectively partitions the overall system bandwidth into multiple (N) orthogonal subbands, tones, subcarriers, bins, frequency channels, etc. Each subband is traditionally associated with a respective subcarrier that may be modulated with data.

Radio frequency (RF) modulated signals can travel over a number of signal paths from a transmitter to a receiver, often with different delays. The received signal includes multiple instances of the transmitted signal, each with different amplitudes and phases. Such time dispersion in wireless channels causes frequency selective fading, e.g., a frequency response that varies across the system bandwidth. In OFDM systems, the many subbands each experience different effective channels and may consequently have different complex channel gains.

A gain estimate of each the wireless channels between the transmitter and the receiver is needed to more effectively receive the data on each subband. Such channel estimation is implemented by sending pilots on selected subbands from the transmitter, and measuring the results for each at the receiver. Each pilot is made up of standard modulation symbols expected by the receiver. For each pilot transmission subband, the channel response can be estimated as the ratio of the pilot symbol received compared to what was known to have been transmitted. Estimates for each of the data subbands that are interspersed with the pilots can then be interpolated.

Pilot transmission represents an overhead in the OFDM system, so the number of pilot transmissions are kept to a minimum. By sending pilot symbols on a subset of the N total subbands, the pilot symbols can be used to derive channel estimates for all subbands of interest. The channel estimate calculation effort can be substantial, e.g., in a spectrally shaped system that does not transmit data/pilot near the band edges, and in a system that cannot transmit data/pilot on zero, DC, or other certain subbands.

FIG. 1 represents an improved wireless transmitter embodiment of the present invention, and is referred to herein by the general reference numeral 100. Transmitter 100 inputs M-complex symbols 102 as data for an M-point complex fast Fourier transformer (FFT) 104. This produces M-complex values 106. N-M number of pilot and null sub-carriers 108 are added to these. So a sub-carrier mapper 110 will be mapping N number of subcarriers, of which M number are data subcarriers and the rest are pilot and null subcarriers. N-number of sub-carriers 112 are input to an N-point complex inverse fast Fourier transform (IFFT) 114. This produces N-number sub-carriers 116 that are given a cyclic/zero prefix in block 118. Then N+N_{CP} sub-carriers 120 are input to power amplifier 122 which provides digital-to-analog conversion (DAC), radio frequency (RF) carriers, and amplification to a wireless transmitter antenna 124.

The frequency domain characteristics of OFDM are retained by the improved transmitter 100 through the use of the IFFT 114. However, not all the available N-number of sub-carriers are assigned to data transmission. Some sub-carriers are given zero values, e.g., at DC and at the edges of the spectrum. Others are given pre-defined values to be pilot sub-carriers for use later in the receiver for channel equalization calculations. The customary OFDM assignments for zero-value sub-carriers and pilot sub-carriers are best retained so as not to alter the frequency-domain power mask of the signal from the improved transmitter 100.

In a conventional OFDM scheme, the data-bearing sub-carriers are directly assigned to all the modulation symbols. In the present invention, the data-bearing sub-carriers 106 are fed from the output of FFT block 104, the input of which is provided by the set of modulation symbols to be transmitted. The size of the FFT is smaller than the IFFT used to create the final transmitted signal, the difference being the number of pilots and zero values sub-carriers used. A zero value suffix or cyclic prefix is applied to each OFDM symbol, as is typical in OFDM systems.

FIG. 2 represents an OFDM radio receiver embodiment of the present invention, and is referred to herein by the general reference numeral 200. An antenna 202 provides wireless signals from transmitter 100 to a low noise amplifier (LNA), channel filter, and analog-to-digital conversion (ADC) block 204. A burst synch detector 206 recovers N+N_{CP} subcarriers 208 for cyclic prefix (CP) removal and overlap-and-add operation block 210. Only the original data subcarriers N 212 are forwarded to an N-point complex FFT block 214, again N>M. The N-number of output values 216 are input to a minimum mean square estimation (MMSE) block 218. A sample 220 of the bust sync is provided to a channel and SNR estimator 222. An SNR estimate 224 is calculated for MMSE equalizer block 218, as well as channel estimates 226 for each of the N-number of subcarriers. A subcarrier de-mapping block 228 produces M-number of data-bearing sub-carriers 230. And an M-point complex IFFT block 232 generates the recovered M-complex symbols 234 that were originally input to transmitter 100.

In receiver 200, the analog and mixed signal hardware follows direct or heterodyne down-conversion, channel filtering and analog to digital conversion at a sampling rate that is at least equal to the bandwidth of the desired signal. Burst synchronization is provided with blocks of samples of size N+N_{CP} aligned to the incoming OFDM symbols. Cyclic prefix removal starts by selecting an appropriate contiguous set of N samples beginning with a sample optimally chosen from within the cyclic prefix. In the case of zero-suffix transmission, e.g., WiMedia MB-OFDM, an overlap-and-add operation may be applied to mimic the effects of cyclic convolution with the channel impulse response. Albeit at the cost of some noise enhancement. Other techniques with similar effects are also useful.

A receiver 200 for transmitter 100 differs from a conventional OFDM receiver in that its frequency domain equalization uses minimum mean square estimation (MMSE) derived taps based on an estimate of each sub-carriers complex channel tap coefficient, and an estimation of the prevailing signal-to-noise ratio (SNR). An inverse fast Fourier transform (IFFT) is applied to the subset of sub-carriers allocated for data transmission, thus reversing the action implemented by the FFT 104 in the transmitter 100.

M-complex modulation symbols are provided as an input an M-point FFT block used for frequency-domain spreading. So FFT size is not equal to some power of two. The transforms can be made very efficient by ensuring the length of the FFT is made up of only small prime factors. For example, if M=100 sub-carriers are used for data, out of a possible N=128, then the FFT can be decomposed using 2×2×5×5.

Sub-carriers are mapped such that the M-number of FFT outputs are allocated among the N-number of available FFT inputs. Pilot carriers are added, and are preferably distributed evenly among the M data-bearing sub-carriers. It is possible to preserve the spectral characteristics of previous OFDM schemes by using an existing mapping scheme from an available standard, while providing the transmission performance advantages of a SCBT scheme.

After the mapping, an N-point IFFT is performed, where N is typically, but not necessarily, a power of 2. The IFFT must have sufficient bit precision to adequately represent the output of the M-point FFT, but this is no more precision than required for an FFT used for normal OFDM reception.

Preferably, the output of the N-point IFFT is augmented by either a cyclic prefix (e.g., as used in wireless LAN) or by appended zeros as an alternative (e.g., as used in WiMedia MB-OFDM). The purpose of this is to allow the naturally occurring linear convolution with the channel impulse response to effectively become a cyclic convolution, allowing frequency domain multiplication to be used as the complementary cyclic deconvolution in the receiver. This greatly simplifies channel equalization in the receiver based on a frequency-domain channel estimate that can be facilitated by means of a suitably designed burst pre-amble.

Finally, typical transmission steps and circuits are provided including upsampling, digital to analog conversion, direct, or heterodyne upconversion to a suitable carrier frequency and RF power amplification.

An N-point complex FFT allows further signal processing to be performed in the frequency-domain, in particular channel equalization. The MMSE equalizer 218 has a single complex tap for each frequency domain sample. The i^{th} tap weight is,

$${MMSE}_{i} = \frac{{H}_{i}^{*}}{{H}_{i} {H}_{i}^{*} + ( 1 / SNR )} ,$$

where Hᵢ is the channel estimate for the ith sub-carrier and SNR is a local estimate of the signal-to-noise ratio applicable to the burst being received. Other types of augmented equalizer structures, including decision feedback equalizer (DFE) processing in the time-domain, may be included to increase performance.

After frequency-domain equalization, the M-number of data-bearing sub-carriers 230 are selected in the appropriate order, e.g., de-mapped. An inverse FFT in block 232 recovers the originally transmitted symbols 234. Subsequent derivation of log-likelihood ratio values, soft symbols, deinterleaving and forward error correction follows.

FIG. 3 represents the improved bit error rate (BER) performance obtained by the present invention's FFT spreading of symbols. Simulations of a ¾-rate convolution encoded QPSK system similar to WiMedia's MB-OFDM Physical layer were conducted. The control case was standard OFDM processing, to act as a reference for the new scheme, which has been labeled as SCBT-LE in the graph of FIG. 3.

From FIG. 3 it can be seen that the improved frequency diversity of the present invention is significant. The effective diversity order can be estimated from the slope of the BER curve, and the improvement is nearly two-fold compared to conventional OFDM.

FIG. 4 shows the power spectral density of conventional OFDM after the pilot sub-carriers removed. FIG. 5 represents the power spectral density of embodiments of the present invention with pilot sub-carriers removed.

The power spectral density masks of the two schemes may be compared by examination of FIGS. 4 and 5. In both cases pilot carriers have been omitted for illustrative purposes. It is clear that the frequency-domain characteristics of the OFDM signal have been preserved with good fidelity (the holes where the pilot carriers should be are clearly visible) while obtaining the frequency diversity benefits of a single-carrier block transmission scheme. It is obvious without further elaboration that advanced spectrum notching schemes such as active interference cancellation can also be applied to the proposed transmission scheme allowing detect-and-avoid or other advanced cognitive radio concepts to be employed to reduce interference to other (narrower band) services that may be sharing the spectrum.

Embodiments of the present invention have a number of useful applications, e.g., ultra-wideband transmission based on enhanced variants of the WiMedia Physical layer standard (Ecma-368 or ISO/IEC 26907). Such enhancements may be proprietary or standardized in future versions. Wireless LAN with enhanced performance at high data rates, improved diversity with a single antenna, may be well suited to hand-held devices. WiMAX enhancements or variants. Improved range at the highest rates, or higher probability of high speed connection for subscribers at the edges of coverage.

While the present invention has been described with reference to several particular example embodiments, those skilled in the art will recognize that many changes may be made thereto without departing from the spirit and scope of the present invention, which is set forth in the following claims.

1. An improved orthogonal frequency division multiplexing (OFDM) communications system, including an inverse fast Fourier transform (IFFT) device in a transmitter to form OFDM symbols, and a corresponding fast Fourier transform (FFT) device at a receiver for frequency-domain processing of a received signal, the improvement comprising:
a transmitter circuit in which data-bearing modulation symbols are spread across many OFDM sub-carriers using a discrete Fourier transform (FFT); and
a receiver circuit that despreads said data-bearing modulation symbols using an inverse discrete Fourier transform (IFFT);
wherein, bit-error-rate (BER) performance overall is improved.

2. The improved OFDM communications system of claim 1, wherein the size of an FFT used for spreading at the transmitter is smaller than that of an IFFT used just after the FFT to create the OFDM symbols for transmission.

3. The improved OFDM communications system of claim 1, wherein low redundancy forward error correction is enabled.

4. A transmitter method for improving bit-error-rate (BER) performance in an orthogonal frequency division multiplexing (OFDM) communications system such that low redundancy forward error correction in high data rate applications, comprising:
using an M-point complex inverse fast Fourier transform (IFFT) device to transform M-complex input symbols into M-complex values;
sub-carrier mapping said M-complex values and N-M additional pilots and null subcarriers, where N>M; and
processing a N-point complex with an inverse fast Fourier transform (IFFT) device for OFDM wireless transmission.

5. A receiver method for improving bit-error-rate (BER) performance in an orthogonal frequency division multiplexing (OFDM) communications system such that low redundancy forward error correction in high data rate applications, comprising:
decoding N-number of OFDM subcarriers that include M-number of data subcarriers and N-M number of pilot and null subcarriers, where N>M;
using an N-point complex fast Fourier transform (FFT) device to despread N-complex values;
sub-carrier de-mapping said N-complex values to remove said N-M additional pilots and null subcarriers; and
processing a N-point complex with an M-point complex inverse fast Fourier transform (IFFT) device for recovery of M-complex symbols.

6. A communications system method for improving bit-error-rate (BER) performance in an orthogonal frequency division multiplexing (OFDM) communications system such that low redundancy forward error correction in high data rate applications, comprising:
using an M-point complex inverse fast Fourier transform (IFFT) device to transform M-complex input symbols into M-complex values;
sub-carrier mapping said M-complex values and N-M additional pilots and null subcarriers, where N>M;
processing a N-point complex with an inverse fast Fourier transform (IFFT) device for OFDM wireless transmission;
with a wireless receiver, decoding N-number of OFDM subcarriers that include M-number of data subcarriers and N-M number of pilot and null subcarriers, where N>M;
using an N-point complex fast Fourier transform (FFT) device to despread N-complex values;
sub-carrier de-mapping said N-complex values to remove said N-M additional pilots and null subcarriers; and
processing a N-point complex with an M-point complex inverse fast Fourier transform (IFFT) device for recovery of M-complex symbols.
